(19) United States
(12) Patent Application Publication
(10) Pub. No.: US 2024/0417576 A1
(43) Pub. Date: Dec. 19, 2024

(54) COMPOSITE PHOTOSENSITIVE STRUCTURE AND METHOD FOR PREPARING THE SAME

(71) Applicant: PLATINUM OPTICS TECHNOLOGY INC., Taoyuan City (TW)

(72) Inventors: Shih-Song Cheng, Taoyuan City (TW); Bo-Xun Zhu, Taoyuan City (TW); Jia-Cheng Chang, Taoyuan City (TW); Kuan-Yu Chen, Taoyuan City (TW); Shi-Lin Zhang, Taoyuan City (TW); Chin-Lung Chen, Taoyuan City (TW)

(73) Assignee: PLATINUM OPTICS TECHNOLOGY INC., Taoyuan City (TW)

(21) Appl. No.: 18/743,900

(22) Filed: Jun. 14, 2024

(30) Foreign Application Priority Data
Jun. 16, 2023 (TW) 112122741

(51) Int. Cl. C09D 5/32; C08K 5/00; C08K 5/521; C08K 5/5333; C09D 133/12; G02B 13/14

(52) U.S. Cl. CPC C09D 5/32; C09D 133/12; G02B 13/14; C08K 5/0091; C08K 5/521; C08K 5/5333

(57) ABSTRACT

Provided are a composite photosensitive element and a method for preparing a composite photosensitive element, and the composite photosensitive element includes a photosensitive element and a near-infrared absorption layer pasted on the photosensitive element, wherein the near-infrared absorption layer includes a copper complex, and the copper complex is formed from a copper compound providing copper ions, phosphoric acid represented by formula 1 herein, and at least one phosphorus-containing compound represented by formulas 2 to 4 herein, wherein the OD value of the near-infrared absorption layer for the incident light wavelength from 930-950 nm is greater than 4. The present disclosure forms a filtering film directly on the photosensitive element instead of using a traditional filter assembly to reduce the size of the assembled product. The filtering film can be further processed and shaped to have functions of micro-lens.

### CROSS-REFERENCE TO RELATED APPLICATION

This application claims the benefit of priority of Taiwan Patent Application No. 112122741, filed Jun. 16, 2023, the entire contents of which are hereby incorporated by reference.

### BACKGROUND

### Technical Field

The present disclosure relates to a composite photosensitive structure, especially to a composite photosensitive structure comprising a photosensitive element and a near-infrared absorption layer formed thereon.

### Description of Associated Art

A well-known photosensitive element briefly comprises components including a micro-lens, a color filter and a photoelectric conversion layer as well as a drive circuit, etc. An array of photosensitive elements can be made by multiple photolithography processes, which is then cut to form the photosensitive element. The photoelectric conversion layer is sensitive to some near-infrared rays in addition to visible light, i.e., sense a broad wavelength range including visible light and part of near-infrared rays. However, electric signals generated by sensing near-infrared rays are considered to be interfering signals which interfere with the display of normal signals. Therefore, it is desirable to filter near-infrared rays effectively from entering the photoelectric conversion layer. In the past, it is typical to install an independent external near-infrared filter on the input side to achieve the purpose of filtering out near-infrared rays, when assembling photosensitive components into optical camera lenses.

However, with the increasing demand for image quality, the problem of using external filters to filter out near-infrared rays is gradually emerging. In addition to the reduction in incident light of the photoelectric conversion layer due to the insufficient visible light transmittance of external near-infrared filters, there is also a problem of optical camera lenses being too large in order to provide space for external filters, leading to the widespread problem of the camera lenses protruding outward in mobile phones, even in high-end mobile phones, thereby increasing the risk of collision, damage, etc. In the trend of miniaturization and thinning of components, it is difficult for optical camera lenses with external near-infrared filters to make significant progress due to the limitations aforementioned.

In addition, it is typical to plate anti-reflective coatings after the formation of a near-infrared absorption layer in the manufacturing process of a near-infrared absorption filter, while the plating process currently used for forming the anti-reflective coatings is performed at a temperature up to 200-300° C., which causes the organic dyes in the near-infrared absorption layer to easily degrade and lose their activity due to high temperature. Thus, there are great limitations in the selection of the organic dyes and in the adjustment and control of the plating process parameters.

### SUMMARY

Given the problems mentioned above, the present disclosure provides a composite photosensitive structure, comprising:
a photosensitive element; and
an infrared absorption layer formed on the photosensitive element, wherein the infrared absorption layer comprises a copper complex which is formed by a copper compound used for providing copper ions, a phosphonic acid represented by Formula 1, and at least one phosphor-containing compound represented by Formulas 2 to 4:

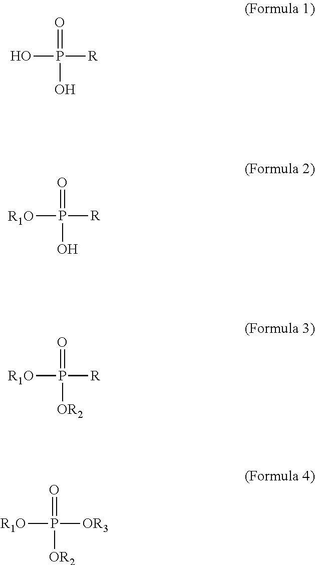

wherein R, R₁, R₂ and R₃ are each independently substituted or unsubstituted C₁-C₁₂ alkyl or C₆-C₁₂ aryl,
wherein the OD value of the near-infrared absorption layer for the incident light wavelengths of 930-950 nm is greater than 4 or about 4.

In an embodiment, the photosensitive element is a charged-couple device (CCD) or a complementary metal-oxide-semiconductor (COMS).

In an embodiment, the substituted or unsubstituted C₁-C₁₂ alkyl is selected from the group consisting of methyl, ethyl, n-propyl, iso-propyl, n-butyl, sec-butyl, iso-butyl, tert-butyl; and the substituted or unsubstituted C₆-C₁₂ aryl is selected from the group consisting of phenyl, naphthyl and chlorophenyl.

In an embodiment, the near-infrared absorption layer has a haze of 0.4% or less.

In an embodiment, an X-ray photoelectron spectroscopy spectrum of the near-infrared absorption layer has at least one principal peak at binding energy of 930-940 eV. In a further embodiment, the at least one principal peak in the X-ray photoelectron spectroscopy spectrum of the near-infrared absorption layer has counts per second of 4500 or more.

In an embodiment, the near-infrared absorption layer has a thickness of 25-150 μm.

In an embodiment, the near-infrared absorption layer further comprises an optical resin which is a thermoplastic resin and/or a phorocurable resin. In a further embodiment, the optical resin is selected from polycarbonates, polyesters, polycycloolefins, polyacrylics, siloxane resins and polyimides. In a further embodiment, the optical resin is methyl methacrylate.

In an embodiment, the copper compound, the phosphonic acid represented by Formula 1, and the at least one phosphorus-containing compound represented by Formulas 2 to 4, together with the solvent, form a dispersion containing a copper complex, and the dispersion and the optical resin are mixed at a weight ratio of 5:1 to 1:1 to form the near-infrared absorption layer.

In an embodiment, the photosensitive element comprises a plurality of photosensitive regions, the near infrared absorption layer is formed on each of the photosensitive regions, and the near infrared absorption layer has a boundary flush with or beyond the boundary of the photosensitive region.

In an embodiment, the near infrared absorption layer has a first surface and an opposite second surface, wherein the second surface contacts the surface of the photosensitive region, and the first surface is flat, convex or concave.

In an embodiment, the near-infrared absorption layer is used as a micro-lens.

The present disclosure further provides a method for preparing a composite photosensitive structure, comprising:
preparing a copper compound used for providing copper ions, a phosphonic acid represented by Formula 1, and at least one phosphor-containing compound represented by Formulas 2 to 4, and forming a coating solution containing a copper complex,

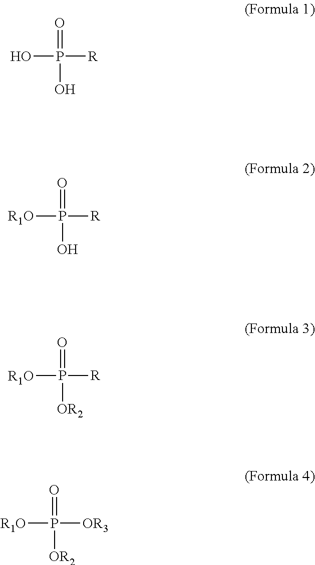

wherein R, R₁, R₂ and R₃ are each independently substituted or unsubstituted C₁-C₁₂ alkyl or C₆-C₁₂ aryl;
coating the coating solution on a wafer containing an array of photosensitive elements, and curing to form a near-infrared absorption layer; and
cutting the wafer to obtain the composite photosensitive structure,
wherein the OD value of the near-infrared absorption layer for the incident light wavelengths of 930-950 nm is greater than 4.

In an embodiment, the photosensitive element is a charged-couple device or a complementary metal-oxide-semiconductor.

In an embodiment, the substituted or unsubstituted C₁-C₁₂ alkyl is selected from the group consisting of methyl, ethyl, n-propyl, iso-propyl, n-butyl, sec-butyl, iso-butyl, tert-butyl; and the substituted or unsubstituted C₆-C₁₂ aryl is selected from the group consisting of phenyl, naphthyl and chlorophenyl.

In an embodiment, the near-infrared absorption layer has a haze of 0.4% or less.

In an embodiment, the X-ray photoelectron spectroscopy spectrum of the near-infrared absorption layer has at least one principal peak at binding energy of 930-940 eV. In a further embodiment, the at least one principal peak in the X-ray photoelectron spectroscopy spectrum of the near-infrared absorption layer has counts per second of 4500 or more.

In an embodiment, the near-infrared absorption layer has a thickness of 25-150 μm or about 25-150 μm.

In an embodiment, the step of forming a coating solution containing a copper complex comprises adding the copper compound, the phosphonic acid and the phosphorus-containing compound into the solvent to form a dispersion. In a further embodiment, the weight ratio of the sum of the copper compound, the phosphonic acid and the phosphorus-containing compound to the solvent is from 1:5 to 1:1. In an embodiment, the step of forming a coating solution containing a copper complex further comprises mixing the dispersion with the optical resin to form a coating solution. In a further embodiment, the weight ratio of the dispersion to the optical resin is from 5:1 to 1:1.

In an embodiment, the optical resin is a thermoplastic resin and/or a phorocurable resin. In a further embodiment, the optical resin is selected from polycarbonates, polyesters, polycycloolefins, polyacrylics, siloxane resins and polyimides. In a further embodiment, the optical resin is methyl methacrylate.

In an embodiment, the curing step is performed by photocuring, and the method further comprises drying the coating solution to remove the solvent prior to the curing.

In an embodiment, the method for preparing a composite photosensitive structure further comprises patterning the near infrared absorption layer by a photolithography process.

In the present disclosure, a composite photosensitive structure is formed by, firstly, formulating a coating solution capable of forming a near-infrared absorption layer that efficiently absorbs incident light at wavelengths of 800-1000 nm, particularly excellently absorbs incident light at a wavelength of 940 nm, while has a very high transmittance for visible light, and then directly coating the coating solution onto a photosensitive element to form the near-infrared absorption layer. An excellent cutoff effect on near-infrared rays can be achieved and the size of an optical camera lens can be significantly reduced by using an optical camera lens with the composite photosensitive structure of the present disclosure without disposing an independent external near-infrared filter. Furthermore, the near-infrared absorption layer can have a specific shape, such as the shape of a convex lens or a concave lens, by introducing a photolithography process during the formation of the near-infrared absorption layer, therefore, the near-infrared absorption layer is also used as a micro-lens, further reducing the size of the optical camera lens.

### BRIEF DESCRIPTION OF THE DRAWINGS

FIGS. 1-4 are schematic diagrams showing the process of an exemplary method for preparing the composite photosensitive structure of the present disclosure.

FIGS. 5-7 are schematic diagrams showing the process of another exemplary method for preparing the composite photosensitive structure of the present disclosure.

FIG. 8 is the X-ray photoelectron spectroscopy spectrum of the near-infrared absorption layer in Preparation Example 1.

### DETAILED DESCRIPTION

The following describes the implementation of the present disclosure through specific embodiments, a person having ordinary skill in the art can easily understand the scope and effect of the present disclosure based on the content recorded herein.

It should be noted that the structures, proportions, sizes, etc. shown in the drawings attached to this specification are only used to exemplify the content disclosed in the specification for the understanding and reading of people skilled in this art, and are not intended to limit the scope of the present disclosure. The present disclosure may also be implemented or applied as described in the various examples. It is also possible to modify or alter the following examples for carrying out the present disclosure without violating its spirit and scope, for different aspects and applications. One of skill in the art will appreciate that structural modifications, changes in proportions, or adjustments in size of the disclosed embodiments will fall within the scope of the technical content disclosed in the present disclosure without affecting the effects that can be produced and the purposes that can be achieved by the present disclosure.

Meanwhile, terms such as “upper”, “first” and “second” recited in the specification are also used for clear description but not for defining the scope capable of being implemented by the present disclosure, the change or adjustment of their relative relationship without substantial alteration of the technical contents are also considered within the implementation scope of the present disclosure.

Unless stated otherwise, “comprising”, “containing” or “having” particular elements used herein means that other elements such as units, components, structures, regions, parts, devices, systems, steps and connection relationships can be also included rather than excluded.

Unless expressly stated otherwise, the singular forms “a”, “an” and “the” also include the plural forms, and the “or” and “and/or” can be used interchangeably herein.

The numeric ranges described herein are inclusive and combinable, and any value falling into the numeric ranges described herein can be used as the upper or lower limit to derive a subrange. For example, a numeric range of “25-200” should be understood to include any subranges between the endpoints 25 and 200, e.g., subranges of 25-150, 30-200, 30-150, etc. In addition, a value falling into each range described herein (e.g., between the upper and lower limits) should be considered to be included in the range described herein.

The first aspect of the present disclosure is a composite photosensitive structure, comprising: a photosensitive element; and a near-infrared absorption layer formed on the photosensitive element.

The photosensitive elements capable of interacting with incident light and generating signals are encompassed in the scope of the present disclosure, and include, but not limited to, a charged-couple device (CCD) or a complementary metal-oxide-semiconductor (CMOS).

The “formed on the photosensitive element” specifically refers to that a near-infrared absorption layer directly contact with a photosensitive element, i.e., a manner capable of making the two contact directly is encompassed in the scope of the present disclosure. For example, a precursor of a near-infrared absorption layer is formed on the surface of a photosensitive element and is further treated to form the near-infrared absorption layer; a near-infrared absorption layer adheres to the surface of a photosensitive element with or without an adhesive, and so on.

The infrared absorption layer of the present disclosure comprises a copper complex which is formed by a copper compound used for providing copper ions, phosphonic acid represented by Formula 1, and at least one phosphor-containing compound represented by Formulas 2 to 4,

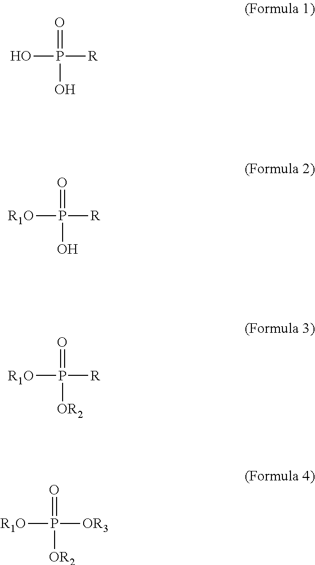

wherein R, R₁, R₂ and R₃ are each independently substituted or unsubstituted C₁-C₁₂ alkyl or C₆-C₁₂ aryl.

The copper complex may be represented by chemical formula Cu²⁺X, wherein Cu²⁺ is provided by a copper compound; and X is contributed by phosphonic acid and/or phosphorus-containing compounds.

The alkyl includes, but not limited to, methyl, ethyl, n-propyl, iso-propyl, n-butyl, sec-butyl, iso-butyl, tert-butyl, pentyl, etc., and examples of the substituted alkyl includes, but not limited to, haloalkyl, hydroxyalkyl, nitroalkykl, alkoxyalkyl, etc. The aryl includes, but not limited to, phenyl, nathphyl, etc., and examples of the substituted aryl includes, but not limited to haloaryl (e.g., chorophenyl), nitroaryl, hydroxyaryl, alkoxyaryl, haloalkylaryl, nitroalkylaryl, hydroxyalkylarykl, etc.

In an embodiment, the phosphonic acid is butylphosphonic acid.

The copper compound for providing copper ions is used mainly as a supply source of copper ions, and may employ well known copper compounds for providing copper ions, such as copper salts, e.g., copper acetate or copper acetate hydrate, as well as anhydrides or hydrates of copper chloride, copper formate, copper stearate, copper benzoate, copper pyrophosphate, copper naphthenate, copper citrate. In an embodiment, the copper compound for providing copper ions is copper acetate.

The phosphorus-containing compound has the function of dispersion to make the components (including the copper complex formed) achieve uniform dispersing without agglutinating with each other. One effect of this function is to make a microcrystal size therein to be 100 nm or less, preferably between 5 nm and 80 nm, or between 20 nm and 60 nm, e.g., 5, 10, 15, 20, 25, 30, 35, 40, 45, 50, 60, 70, 80, 90 and 100 nm, or e.g., about 5, about 10, about 15, about 20, about 25, about 30, about 35, about 40, about 45, about 50, about 60, about 70, about 80, or about 90. Sufficient near-infrared absorption property can be exhibited at a microcrystal size of 5 nm or more; while the product prepared has a relatively low haze due to the small number average particle size when the microcrystal size is 100 nm or less.

The copper complex of the present disclosure may be prepared from a near-infrared absorption composition. The near-infrared absorption composition comprises the copper compound, the phosphonic acid and the phosphorus-containing compound described above, and each component reacts with each other to form the copper complex. In the present disclosure, the proportions of each component can be adjusted as needed. For example, in the near-infrared absorption composition, the copper compound for providing copper ions may be of 1-150 weight parts, such as 1, 5, 10, 15, 20, 25, 30, 35, 40, 45, 50, 55, 60, 65, 70, 75, 80, 85, 90, 95, 100, 105, 110, 115, 120, 125, 130, 135, 140, 145 or 150 weight parts; the phosphonic acid may be of 1-100 weight parts, such as 1, 5, 10, 15, 20, 25, 30, 35, 40, 45, 50, 55, 60, 65, 70, 75, 80, 85, 90, 95 or 100 weight parts; and the phosphorus-containing compounds may be of 1-90 weight parts in total, such as 1, 5, 10, 15, 20, 25, 30 35, 40, 45, 50, 55, 60, 65, 70, 75, 80, 85 or 90 weight parts.

In an embodiment, the near-infrared absorption composition comprises the phosphorus-containing compounds represented by Formulas 2 to 4 concurrently with the proportions can be adjusted as needed, for example, in the near-infrared absorption composition, the phosphorus-containing compound represented by Formula 2 may be of 1-90 weight parts, the phosphorus-containing compound represented by Formula 3 may be of 1-90 weight parts the phosphorus-containing compound represented by Formula 4 may be of 1-90 weight parts, wherein the phosphorus-containing compounds represented by Formulas 2 to 4 each may be, for example, of 1, 5, 10, 15, 20, 25, 30, 35, 40, 45, 50, 55, 60, 65, 70, 75, 80, 85 or 90 weight parts. In a further embodiment, the ratio of the phosphorus-containing compound represented by Formula 2: the phosphorus-containing compound represented by Formula 3: the phosphorus-containing compound represented by Formula 4 is 20:20:50.

In an embodiment, the near-infrared absorption composition may be the form of a dispersion, i.e., the near-infrared absorption composition further comprises a solvent in addition to the copper compound, the phosphonic acid and the phosphorus-containing compound. During formulation, the copper compound, the phosphonic acid and the phosphorus-containing compound may be added into the solvent and mixed, the ratio of those components to the solvent may be 1:5 to 1:1, such as 1:3, but not limited thereto.

The solvent may be selected from well-known solvents, including but not limited to, water, alcohols, ketones, ethers, esters, aromatic hydrocarbons, halogenated hydrocarbons, dimethylformamide, dimethylacetamide, dimethyl sulfoxide, sulfolane, etc. Specifically, the alcohols are, for example, methanol, ethanol, propanol, etc. The esters are, for example, alkyl formates, alkyl acetates, alkyl propionate, alkyl butyrate, alkyl lactate, alkyl alkoxyacetate, alkyl 3-alkoxypropionate, alkyl 2-alkoxypropionate, alkyl 2-alkoxy-2-methylpropionate, alkyl pyruvate, alkyl acetylacetate, alkyl 2-oxobutyrate, etc. The ethers are, for example, diethylene glycol dimethyl ether, tetrahydrofuran, ethylene glycol monomethyl ether, ethylene glycol monoethyl ether, methylcellosolve acetate, ethylcellosolve acetate, diethylene glycol monomethyl ether, diethylene glycol monoethyl ether, diethylene glycol monobutyl ether, propylene glycol monomethyl ether, propylene glycol monomethyl ether acetate, propylene glycol monoethyl acetate, propylene glycol monopropyl ether acetate, etc. The ketones are, for example, methyl ethyl ketone, cyclohexanone, cyclopentanone, 2-heptanone, 3-heptanone, etc. The aromatic hydrocarbons are, for example, toluene, xylene, etc.

The mixing is, for example, stirring thoroughly at room temperature (e.g., 25° C.), such as for 4 hours or more, 6 hours or more, 8 hours or more, but not limited thereto.

In the present disclosure, the near-infrared absorption composition in the form of a dispersion may be mixed with an optical resin to form a near-infrared absorption composition in the form of coating solution for subsequent formation of a near-infrared absorption layer. The ratio of the dispersion to the optical resin may be 5:1 to 1:1, or 3:1 to 1:1, such as 0.65:0.35, but not limited thereto. The near-infrared absorption composition in the form of a coating solution is used to be applied onto a substrate and baked for curing, to form a near-infrared absorption layer.

The optical resin may be a thermoplastic resin and/or a phorocurable resin. In an embodiment, the optical resin is selected from polycarbonates, polyesters, polycycloolefins, polyacrylics, siloxane resins and polyimides. In a further embodiment, the optical resin is a siloxane resin. In a further embodiment, the optical resin is methyl methacrylate.

In an embodiment, the near-infrared absorption composition may be further added with a polymerization initiator, such as a photopolymerization initiator, thereby the optical resin may be subjected to polymerization by light irradiation. A well-known polymerization initiator, including but not limited to, azodiisobutyronitrile, may be used. In an embodiment, a solvent may be added to facilitate uniform mixing, and those well-known may be used, including but not limited to, those mentioned herein. In an embodiment, in order to facilitate curing process, a curing agent, such as a photocuring agent, may be further added, thereby curing may be performed to form a film by light irradiation.

In an embodiment, in order to further improve the optical properties, such as further enhance the cutoff for near-infrared rays and ultraviolet rays, of the near-infrared absorption layer, an absorption dye may be further included. In an embodiment, the absorption dye comprises a near-infrared absorption dye and/or an ultraviolet absorption dye.

The near-infrared absorption dyes may be, for example, azo compounds, di-iminium compounds, benzene dithiol metal complexes, squaraine compounds, cyanine compounds and phthalocyanine compounds, and may adjust the maximum absorption wavelength to be between 650 nm and 1100 nm, or more specifically between 650 nm and 750 nm. The ultraviolet absorption dye may be, for example, azomethylene compounds, indole compounds, ketone compounds, benzimazole compounds and triazine compounds.

In an embodiment, in order to maintain the better light transmittance, the near-infrared absorption layer has a haze of 0.4% or less, 0.3% or 0.2% or less, e.g., 0.4%, 0.35%, 0.3%, 0.25%, 0.2%, 0.19%, 0.18%, 0.17%, 0.16%, 0.15%, 0.14%, 0.13%, 0.12%, 0.11% or 0.1%.

The thickness of the near-infrared absorption layer also has an effect on the properties of near-infrared absorption. In general, the cutoff capability for near-infrared rays increases as the thickness of the near-infrared absorption layer increases, however, this doesn't satisfy the requirement for thinning; while the cutoff capability for near-infrared rays reduces as the thickness of the near-infrared absorption layer reduces. In an embodiment, the near-infrared absorption layer of the present disclosure can achieve excellent cutoff capability for near-infrared rays even if its thickness is small. Specifically, the near-infrared absorption layer has a thickness between 25 μm and 150 μm, between 50 μm and 150 μm, or between 100 μm and 150 μm, e.g., 25 μm, 30 μm, 35 μm, 40 μm, 45 μm, 50 μm, 60 μm, 70 μm, 80 μm, 90 μm, 100 μm, 110 μm, 120 μm, 125 μm, 130 μm, 135 μm, 140 μm, 145 μm, 146 μm, 147 μm, or 150 μm.

In an embodiment, the X-ray photoelectron spectroscopy spectrum of the near-infrared absorption layer of the present disclosure has at least one principal peak at binding energy of 930-940 eV. In an embodiment, the at least one principal peak has counts per second of 4500 or more, 4600 or more, 4700 or more, 4800 or more, 4900 or more, or 5000 or more.

In an embodiment, for the incident light wavelength range of 930-950 nm (including for the incident light wavelength of 940 nm), the near-infrared absorption layer of the present disclosure has maximum transmittance of 0.1% or less, less than 0.1%, 0.05% or less, less than 0.05%, 0.01% or less, less than 0.01%, 0.0005 or less, or less than 0.005%, e.g., 0.1%, 0.09%, 0.08%, 0.07%, 0.06%, 0.05%, 0.04%, 0.03%, 0.02%, 0.01%, 0.009%, 0.008%, 0.007%, 0.006%, 0.005%, 0.004%, 0.003%, 0.002%, 0.001%. In another aspect, for the incident light wavelength range of 930-950 nm (including for the incident light wavelength of 940 nm), the OD value is 3 or more, more than 3, 3.5 or more, more than 3.5, 4 or more, more than 4, 4.5 or more, or more than 4.5, e.g., 3, 3.1, 3.2, 3.3, 3.4, 3.5, 3.6, 3.7, 3.8, 3.9, 4, 4.1, 4.2, 4.3, 4.4, 4.5, 4.6, 4.7, 4.8, 4.9. In an embodiment, for the incident light wavelength range of 460-560 nm, the near-infrared absorption layer has minimum transmittance of 80% or more or 85% or more, e.g., 80%, 81%, 82%, 83%, 84%, 85%, 86%, 87%, 88%, 89% or 90%.

In an embodiment, the near-infrared absorption layer has a passband overlaying with a wavelength range of 300-850 nm, 300-800 nm, or 350-750 nm, and the central wavelength of the passband is in the wavelength range of 300-850 nm, 300-800 nm, 350-750 nm, 400-700 nm, 450-650 nm, 500-600 nm, or 500-550 nm. Herein, the “passband” refers to a range within which transmittance of 50% or more is exhibited for incident light in the wavelength range, the “central wavelength of the passband” refers to an average value of the two incident light wavelengths corresponding to the 50% transmittance exhibited for incident light.

In an embodiment, there is a shift in the central wavelength of the passband when incident light irradiates the near-infrared absorption layer at incident angles of from 0° to 30°, wherein the shift is of 1.4 nm or less, e.g., 1.4 nm, 1.3 nm, 1.2 nm, or 1.1 nm. In an embodiment, there is a shift in the central wavelength of the passband when incident light irradiates the near-infrared absorption layer at incident angles of from 0° to 35°, wherein the shift if of 1.9 nm or less, e.g., 1.9 nm, 1.8 nm, or 1.7 nm.

In the composite photosensitive structure of the present disclosure, the photosensitive element comprises a plurality of photosensitive regions, and the near infrared absorption layer is formed on each photosensitive region. For example, in a condition that the photosensitive element is a wafer which has not been cut and has a plurality of photosensitive units, the photosensitive units are the photosensitive regions referred to herein, and a near-infrared absorption layer may be formed on the whole wafer and may be further treated. More specifically, the near-infrared absorption layer may contact the plurality of photosensitive units. In an embodiment, the near-infrared absorption layer has a boundary flush with or beyond the boundary of the photosensitive regions to ensure that infrared rays are cut off by the near-infrared absorption layer without entering the photosensitive regions therebeneath.

In an embodiment, the near infrared absorption layer of the composite photosensitive structure of the present disclosure has a first surface and an opposite second surface, wherein the second surface of the near-infrared absorption layer contacts the surface of the photosensitive region, and the first surface of the near-infrared absorption layer is flat, convex or concave. Here, the near-infrared absorption layer may be treated to make the first surface to be flat, convex or concave, e.g., by etching, laser cutting, grinding, photolithography process, etc., and the process may be performed before, during or after forming the near-infrared absorption layer on the photosensitive regions. The convex surface refers to the first surface protruding outwards relative to the second surface; and the concave surface refers to the first surface depressing inwards relative to the second surface. In an embodiment, the first surface of the near-infrared absorption layer is used as the incident surface for light to make the light beam confluence or diffuse due to the first surface, thereby the near-infrared absorption layer is used as a micro-lens.

The second aspect of the present disclosure provides a method for preparing a composite photosensitive structure, comprising:
preparing a copper compound used for providing copper ions, a phosphonic acid represented by Formula 1, and at least one phosphor-containing compound represented by Formulas 2 to 4, and forming a coating solution containing a copper complex,

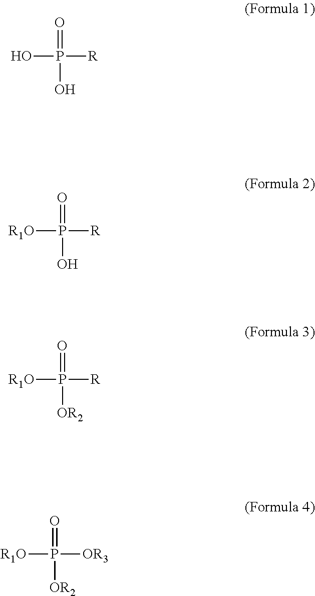

wherein R, R₁, R₂ and R₃ are each independently substituted or unsubstituted C₁-C₁₂ alkyl or C₆-C₁₂ aryl;
coating the coating solution on a wafer containing an array of photosensitive elements, and curing to form a near-infrared absorption layer; and
cutting the wafer to obtain the composite photosensitive structure.

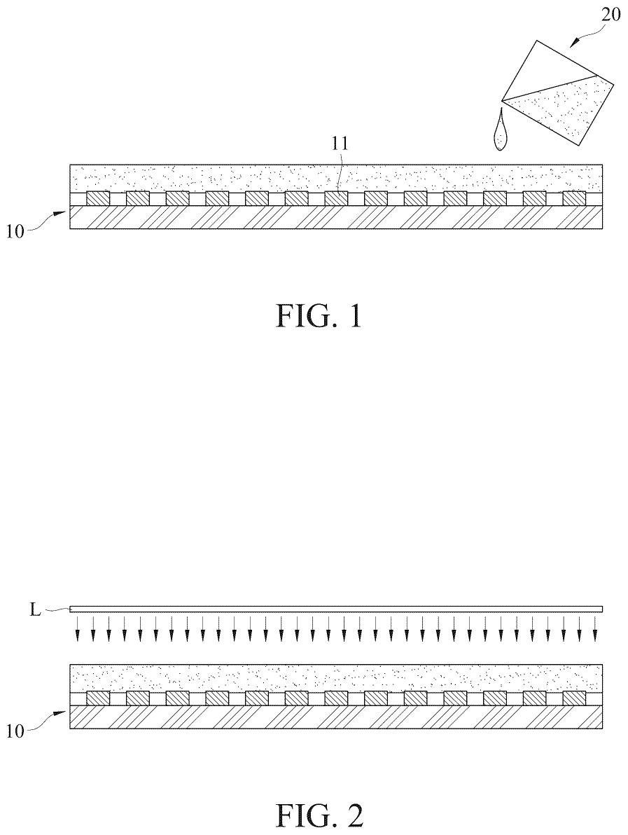

The specific exemplary embodiment is illustrated in FIG. 1 to FIG. 4. Firstly, a copper compound for providing copper ions, phosphonic acid, and a phosphorus-containing compound are prepared and mixed with a solvent to form a dispersion. Here, the mixing may be performed by mixing the copper compound with a solvent first to form a first mixture, additionally mixing the phosphorus-containing compound with a solvent to form a second mixture, and mixing the first mixture, the second mixture and the phosphonic acid to form the dispersion. Here, a copper complex in the dispersion is formed due to the interaction of the components.

To form a coating solution, the dispersion is further mixed with an optical resin. The optical resin may be those described in the first aspect herein.

In an embodiment, the dispersion is dried into powder first, the powder is subsequently added to a second solvent to form a dispersion, and then the dispersion is mixed with an optical resin. The second solvent may be selected from the solvents described in the first aspect herein.

Where an absorption dye is added, the absorption dye may be optionally added into the dispersion/coating solution, e.g., the absorption dye is added into the dispersion prior to mixing with the optical resin, is added along with the dispersion into the optical resin and then mixed, or is added into the coating solution after the dispersion has been mixed with the optical resin.

As shown in FIG. 1, coating solution 20 is coated on wafer 10 containing an array of photosensitive elements (comprising a plurality of photosensitive regions 11). Optionally, before or after coating, the coating solution is degassed, e.g., by ultra-sonication, placing in a negative pressure environment or both. The manners of coating are not limited herein, e.g., coating may be performed by spin coating, spray coating, blade coating, roller coating, dipping, etc.

Then, the coating solution is cured to form a near-infrared absorption layer. As illustrated in FIG. 2, the curing may be photocuring by irradiating the coating solution with light source L to form near-infrared absorption layer 21 on whole wafer 10.

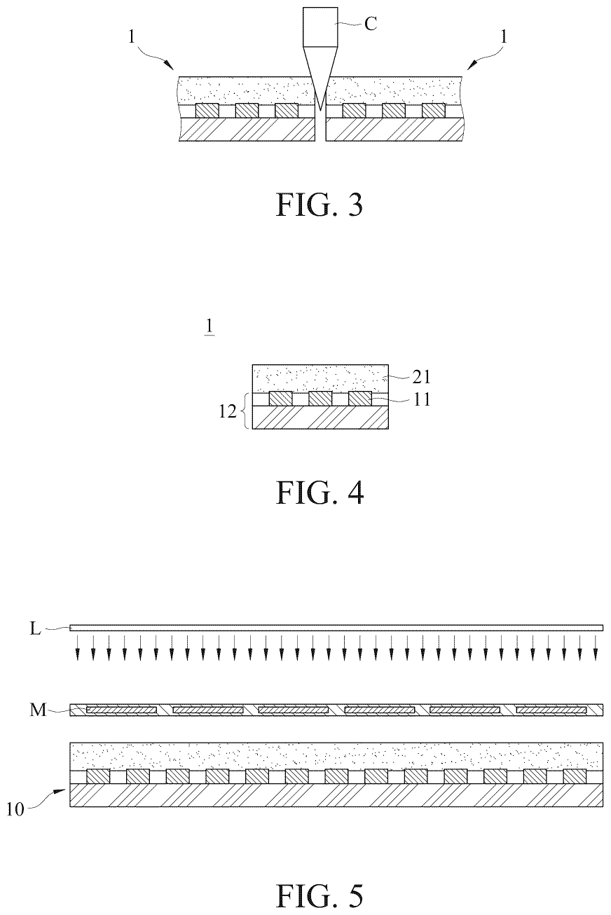

Further as shown in FIG. 3 and FIG. 4, wafer 10 is cut with cutting device C containing such as a laser or a diamond blade, to give photosensitive structure 1, which has photosensitive element 12 and near-infrared absorption layer 21 formed thereon.

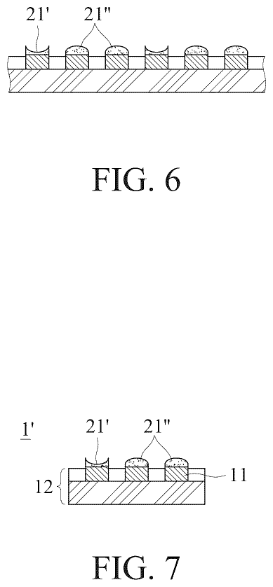

FIG. 5 to FIG. 7 show another specific embodiment of a method for preparing a composite photosensitive structure, with an additional step of patterning the near-infrared absorption layer as compared to FIG. 1 to FIG. 4. The processes shown in FIG. 5 to FIG. 7 are subsequent to FIG. 1 and correspond to FIG. 2 to FIG. 4, respectively, with the difference that the photolithography process is further introduced in FIG. 5 relative to FIG. 2. Specifically, mask M, such as a grayscale mask, is disposed to allow the coating solution therebeneath to be exposed selectively, thereby yielding near-infrared absorption layers 21′, 21″ having particular patterns or in particular shapes. The particular patterns or particular shapes, as illustrated in FIG. 6 and FIG. 7, allow the first surface of the near-infrared absorption layer to protrude upwards or depress downwards.

In an embodiment, the coating solution on the whole wafer forms patterned near-infrared absorption layers separated from each other over the positions corresponding to various photosensitive regions 11, such as near-infrared absorption layers 21′, 21″ shown in FIG. 6 and FIG. 7. The “separated from each other” described herein specifically refers to that there is no contact between any two adjacent near-infrared absorption layers, which can be achieved via the photolithography process described above.

In an embodiment, the coating solution is dried (e.g., dried at 120° C.) to remove the solvent prior to curing.

### EXAMPLES

Further details will be described in the present disclosure by referencing to following specific Examples which are never in any sense intended to limit the scope of the present disclosure.

### Preparation Example 1. Near-Infrared Absorption Layer

150 Weight parts of copper acetate were mixed with 15000 weight parts of ethanol and stirred at room temperature for 1.5 hrs to form a first mixture. Additionally, 20 weight parts of the phosphorus-containing compound represented by Formula 2 (plysurf A242G, purchased from Daiichi Pharmaceutical Co., Ltd.), 20 weight parts of the phosphorus-containing compound represented by Formula 3 (plysurf W542C, purchased from Daiichi Pharmaceutical Co., Ltd.,) and 50 weight parts of the phosphorus-containing compound represented by Formula 4 (plysurf A285C, purchased from Daiichi Pharmaceutical Co., Ltd.) were mixed with 1500 weight parts of ethanol to form a second mixture. The first and the second mixtures were mixed and stirred at room temperature for 1 hr, and then 100 weight parts of butylphosphonic acid were added and stirred at room temperature to react for 3 hrs. Thereafter, the reaction mixture was placed in an oven at 85° C. for 12 hrs to obtain powder. The powder was mixed with xylene at a weight ratio of 1:3 to form a dispersion, the dispersion was mixed with methyl methacrylate (MMA) at a weight ratio of 0.65:0.35 to form a coating solution, and the coating solution was coated on a substrate and baked at 70° C. for 30 minutes, yielding a near-infrared absorption layer.

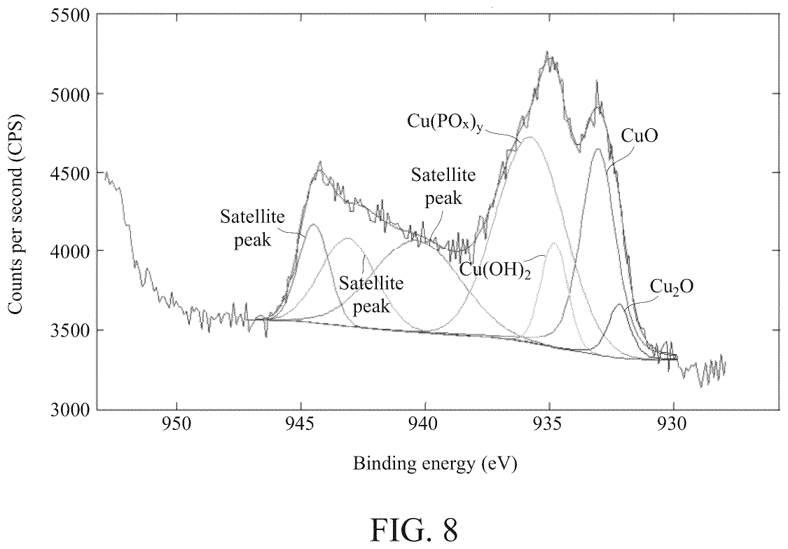

An X-ray photoelectron spectroscopy (ESCA/XPS) measurement was performed on the near-infrared absorption layer, and the X-ray photoelectron spectroscopy spectrum was shown in FIG. 8. Characteristic peaks related to the copper complex (Cu(POₓ)_{y}, CuO, Cu₂O, Cu(OH)₂) at binding energy of 930-940 eV were observed. Also, peaks occurred at binding energy of 940 eV or more were satellite peaks.

### Example 1

A dispersion and a coating solution were prepared according to the method of Preparation Example 1, except that 0.5 g of azobisisobutyronitrile (AIBN) as a photopolymerization initiator and a suitable amount of propylene glycol methyl ether (PGME) as a solvent were added into the coating solution additionally, and the mixture was degassed by ultra-sonication in a negative pressure environment. The coating solution was spin-coated onto a wafer with an array of photosensitive elements formed. The coating layer was baked at 120° C. to remove the solvent and then irradiated with ultraviolet rays, to form a near-infrared absorption layer on the surface of the array of photosensitive elements. Finally, the wafer was cut by laser to yield a composite photosensitive structure.

### Example 2

A near-infrared absorption layer was formed on a wafer having an array of photosensitive elements formed according to Example 1, expect that a grayscale mask was disposed on the wafer after the spin coating step and before irradiating with ultraviolet rays to allow the coating layer to be exposed selectively. Thereby, a patterned near-infrared absorption layer was formed on the surface of the array of photosensitive elements, yielding a composite photosensitive structure.

The embodiments and specific examples described above are not intended to limit the present disclosure. The technical features or schemes listed can be combined with one another. The present disclosure can be implemented or applied by other different execution modes. Details recorded herein can be altered or modified differently according to different viewpoints and applications without departing from the present disclosure.

What is claimed is:

1. A composite photosensitive structure, comprising:
a photosensitive element; and
an infrared absorption layer formed on the photosensitive element, wherein the infrared absorption layer comprises a copper complex which is formed by a copper compound for providing copper ions, a phosphonic acid represented by Formula 1, and at least one phosphor-containing compound represented by Formulas 2 to 4: 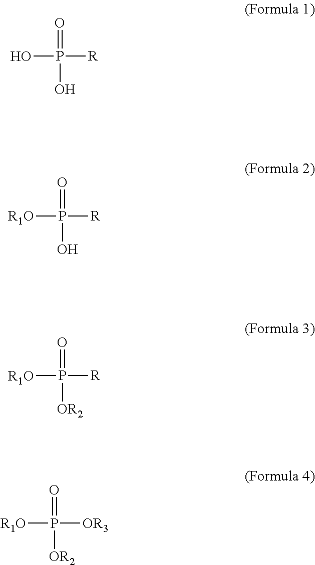
wherein R, R₁, R₂ and R₃ are each independently substituted or unsubstituted C₁-C₁₂ alkyl or C₆-C₁₂ aryl,
wherein the OD value of the near-infrared absorption layer for the incident light wavelengths from 930-950 nm is greater than 4

2. The composite photosensitive structure of claim 1, wherein the photosensitive element is a charged-couple device or a complementary metal oxide semiconductor.

3. The composite photosensitive structure of claim 1, wherein the substituted or unsubstituted C₁-C₁₂ alkyl is selected from the group consisting of methyl, ethyl, n-propyl, iso-propyl, n-butyl, sec-butyl, iso-butyl, tert-butyl; and the substituted or unsubstituted C₆-C₁₂ aryl is selected from the group consisting of phenyl, naphthyl and chlorophenyl.

4. The composite photosensitive structure of claim 1, wherein the near-infrared absorption layer has a haze of 0.4% or less.

5. The composite photosensitive structure of claim 1, wherein an X-ray photoelectron spectroscopy spectrum of the near-infrared absorption layer has at least one principal peak at binding energy of 930-940 eV.

6. The composite photosensitive structure of claim 5, wherein the at least one principal peak has counts per second of 4500 or more.

7. The composite photosensitive structure of claim 1, wherein the near-infrared absorption layer has a thickness of 25-150 μm.

8. The composite photosensitive structure of claim 1, wherein the photosensitive element comprises a plurality of photosensitive regions, the near-infrared absorption layer is formed on each of the photosensitive regions, and the near-infrared absorption layer has a boundary flush with or beyond the boundary of the photosensitive region.

9. The composite photosensitive structure of claim 1, wherein the near-infrared absorption layer has a first surface and an opposite second surface, the second surface contacts the surface of the photosensitive region, and the first surface is flat, convex or concave.

10. The composite photosensitive structure of claim 9, wherein the near-infrared absorption layer is used as a micro-lens.

11. A method for preparing a composite photosensitive structure, comprising:
providing a copper compound used for providing copper ions, a phosphonic acid represented by Formula 1, and at least one phosphor-containing compound represented by Formulas 2 to 4, to form a coating solution containing a copper complex, 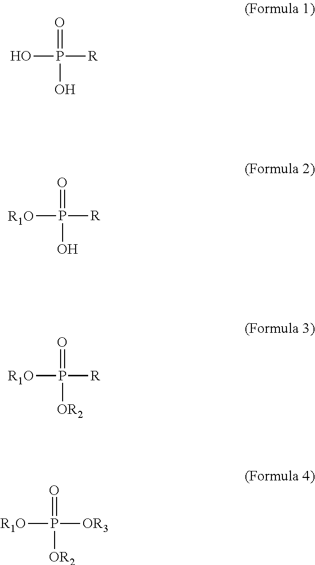
wherein R, R₁, R₂ and R₃ are each independently substituted or unsubstituted C₁-C₁₂ alkyl or C₆-C₁₂ aryl;
coating the coating solution on a wafer containing an array of photosensitive elements, and curing to form a near-infrared absorption layer; and
cutting the wafer to obtain the composite photosensitive structure,
wherein the OD value of the near-infrared absorption layer for the incident light wavelengths of 930-950 nm is greater than 4

12. The method of claim 11, wherein the photosensitive element is a charged-couple device or a complementary metal oxide semiconductor.

13. The method of claim 11, wherein the substituted or unsubstituted C₁-C₁₂ alkyl is selected from the group consisting of methyl, ethyl, n-propyl, iso-propyl, n-butyl, sec-butyl, iso-butyl, tert-butyl; and the substituted or unsubstituted C₆-C₁₂ aryl is selected from the group consisting of phenyl, naphthyl and chlorophenyl.

14. The method of claim 11, wherein the near-infrared absorption layer has a haze of 0.4% or less.

15. The method of claim 11, wherein an X-ray photoelectron spectroscopy spectrum of the near-infrared absorption layer has at least one principal peak at binding energy of 930-940 eV.

16. The method of claim 15, wherein the at least one principal peak has counts per second of 4500 or more.

17. The method of claim 16, wherein the near-infrared absorption layer has a thickness of 25-150 μm.

18. The method of claim 11, wherein the curing is photocuring, and the method further comprises drying the coating solution to remove the solvent prior to the curing.

19. The method of claim 11, further comprising patterning the near-infrared absorption layer by a photolithography process.
